(19) United States
(12) Patent Application Publication
(10) Pub. No.: US 2004/0202741 A1
(43) Pub. Date: Oct. 14, 2004

(54) Method and apparatus for melt spinning and cooling a group of filaments

(75) Inventors: Matthias Schemken, Neumunster (DE); Joachim Brenk, Armstedt (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SAURER GMBH & CO.KG

(21) Appl. No.: 10/819,757

(22) Filed: Apr. 6, 2004

(30) Foreign Application Priority Data
Apr. 12, 2003 (DE) 103 16 914.8

(51) Int. Cl. B28B 5/00; D01D 5/08; B29D 28/00

(52) U.S. Cl. 425/72.2; 264/172.17

(57) ABSTRACT

A method and an apparatus for melt spinning and cooling a group of filaments, wherein the group of filaments is extruded through a plurality of spin holes of an annular spinneret to form an annular filament sheet. The group of filaments is then cooled by an inner airflow, which is generated by an air diffuser in the interior of the filament sheet. To obtain in the case of a particularly high filament density of the filament sheet a particularly uniform cooling of the inner and outer filaments of the filament group, the group of filaments is additionally cooled by a second outer cooling airflow which is generated by an additional air discharge member on the outer side of the filament sheet.

### BACKGROUND OF THE INVENTION

The invention relates to a method and apparatus for melt spinning and cooling a group of filaments, of the general type disclosed in DE 198 21 778 A1 and corresponding U.S. Pat. No. 6,174,474.

In the melt spinning of strands of synthetic fibers or yarns, a plurality of fine, strandlike filaments are extruded through the spin holes of a spinneret. To this end, a molten polymer is advanced to the spinneret under a high pressure. To form a strand of fibers or a plurality of yarns, the plurality of the strandlike filaments are combined as a whole or in bundles. Before being combined, the filaments are quenched by a cooling airflow, so that the molten state of the filaments becomes a solidified state directly upon leaving the spin hole. For the quality of the fiber strand or the yarns, a uniform cooling of all filaments is of very great importance.

For cooling a very large number of filaments, known methods and apparatus are used, wherein the plurality of the filaments are extruded through an annular spinneret to form an annular filament sheet, and wherein inside the filament sheet, a cooling airflow is generated by an air diffuser in the radial direction from the inside outward which effects a cooling of the group of filaments. A method and an apparatus of this type are disclosed, for example, in the above referenced patent documents. The airflow for cooling the group of filaments is generated by an air diffuser, which comprises a porous jacket, so that from the entire circumference of the air diffuser, a uniform cooling airflow radially emerges and penetrates the filament sheet for cooling the filaments. In this process, an adjustment of the intensity of the cooling airflow makes it possible to expand the filament sheet, so that the filaments are penetrated and cooled.

To be able to follow the trend toward higher production speeds and higher outputs, still larger numbers of filaments are extruded by means of spinnerets, which comprise a very large number and great density of spin holes, so that the group of filaments of a relatively great density advances in the filament sheet. In such cases, the cooling airflow of the known method and known apparatus is heated from the inside outward as it passes through the filament sheet. This action results in that the outer filaments of the filament sheet are not cooled to the same extent as are the inner filaments of the filament sheet. These differences in the cooling have a very disadvantageous effect on the quality of the fiber strand or the yarns.

Methods and apparatus are also disclosed, for example, in DE 101 09 838 A1 or U.S. Pat. No. 3,299,469, wherein a cooling airflow is guided from the outside inward through the filament sheet for cooling the group of filaments. Such systems, however, are subjected to the same problematic situation, namely that the heating of the cooling air in the filament sheet causes the outer filaments to be cooled differently than the inner filaments. In addition, the cooling air flow acting upon the filament sheet from the outside causes the filament sheet to be compressed, so that in the extreme case, individual filaments of the filament sheet combine with one another.

For cooling an annular filament sheet, there are also known systems wherein a relatively sharp cooling air jet penetrates the filament sheet downstream of the spinneret. Methods and apparatus of this type are disclosed in DE 195 44 662 A1 or DE 197 00 169 A1, however, they employ very short cooling lengths, which require correspondingly slow spinning speeds to effect an adequate cooling.

Both U.S. Pat. No. 3,824,050 and U.S. Pat. No. 3,111,368 disclose methods and apparatus wherein a cooling airflow generated parallel to the filament group advances along the filament group. This, however, gives rise to the problem that the filaments advancing in the interior of the filament sheet are inadequately cooled. Only the filaments advancing parallel to the cooling airflow undergo an adequate cooling.

It is therefore an object of the invention to improve a method and an apparatus of the initially described type such that it is possible to uniformly cool a group of filaments of a great density that are extruded to form an annular filament sheet.

### SUMMARY OF THE INVENTION

The above and other objects and advantages are achieved by a melt spinning method and apparatus wherein the downwardly advancing annular group of filaments is cooled by an inner cooling airflow that is generated from an air diffuser in the interior of the group of filaments, and by an outer cooling airflow that is generated outside the group of filaments.

The invention thus departs from procedures of the art, which are essentially based on intensifying by additional measures the cooling air flow that is directed to the filament sheet from one direction. Contrary to that, the invention elects an approach, which is based on an inner first cooling airflow that acts upon the group of filaments, and a second cooling airflow that is active from the outside. Despite the reservation that the collision of the cooling airflows could lead to unacceptable turbulences and thus to an unacceptable impairment of the smooth advance of the filaments, it has been found that all filaments of the filament group are very uniformly cooled. In this connection, the outer cooling airflow is preferably adjusted such that the advantages provided by the inner cooling airflow, such as an expansion of the filament sheet, remain unaffected.

To this extent, a further development of the invention has shown to be especially satisfactory, wherein the outer cooling airflow is generated with an outflow that is directed parallel to the group of filaments. To this end, the apparatus of the invention comprises an air discharge member which includes an annular air nozzle with an outlet opening that is oriented parallel to the group of filaments.

To obtain in the case of relatively coarse filaments an intensive and adequate cooling of the outer filaments of the group of filaments, it is preferred to use the further embodiment of the invention, wherein the outer cooling airflow is directed substantially parallel and oppositely to the direction of advance of the filament group. To this end, the air nozzle is directed with its outlet opening against the direction of advance of the filament group.

To cool very fine filaments, a variant of the invention is proposed, wherein the outer cooling airflow is directed substantially parallel in the direction of advance of the filament group. With that it is possible to adjust the direct influence of the outer cooling airflow such that the fine outer filaments of the group are not pushed away in an unacceptable manner. In this connection, the air nozzle can advantageously be arranged in the immediate vicinity of the spinning device, so that the outer cooling airflow is able to act upon the outer filaments of the filament sheet over the entire cooling length. A parallel guided cooling airflow makes it possible to minimize from the outside a direct airflow toward the filament sheet.

To obtain a cooling effect utilizing the ambient air of the environment that is entrained by the filament sheet, it is preferred to use a further development of the invention, wherein the outer cooling air flow is advanced in spaced relationship with the filament group into the outer periphery of the filament sheet. In this case, air is not directed into the group of filaments. In the apparatus of the invention, it is possible to realize this variant in that the air nozzle is arranged in spaced relationship with the filament sheet such that the cooling airflow leaving the outlet opening mixes with the ambient air and is directly guided into the outer periphery of the filament group.

To increase flexibility with respect to adjusting the outer cooling airflow, it is furthermore proposed to generate the outer cooling airflow with a variable outflow. In so doing, it is possible to adjust in particular a predetermined angular direction of the outflow relative to the group of filaments. To this end an adjustment member or shutter is associated with the air discharge means, so that the outer cooling airflow can be guided in any desired blowing direction relative to the filament group.

A further measure for a flexible cooling of the filament group lies in that the outer cooling airflow is generated in a variable position downstream of the annular spinneret. With that it is possible to limit the effect of the outer cooling airflow to the group of filaments within a certain section of the cooling length. Such a variant of the method may be achieved in a simple way by an air discharge member that is vertically adjustable along the cooling length. A further advantage of this measure lies in that possible positions of applying the air discharge member may be adjusted before starting the process, for enabling, for example, a spinning startup of the filament group.

To influence the inner cooling airflow through the air diffuser, it will be especially advantageous, when the air diffuser is made axially adjustable relative a holding device. This makes it possible to adjust different heights of the air diffuser with a corresponding selection of the centering elements.

### BRIEF DESCRIPTION OF THE DRAWINGS

In the following the method of the invention is described in greater detail by means of several embodiments of the apparatus according to the invention and with reference to the attached drawings, in which:

FIG. 1 is a schematic cross sectional view of a first embodiment of the apparatus according to the invention; and

FIGS. 2 and 3 are schematic cross sectional views of further embodiments of the apparatus according to the invention.

### DETAILED DESCRIPTION OF THE PREFERRED EMBODIMENTS

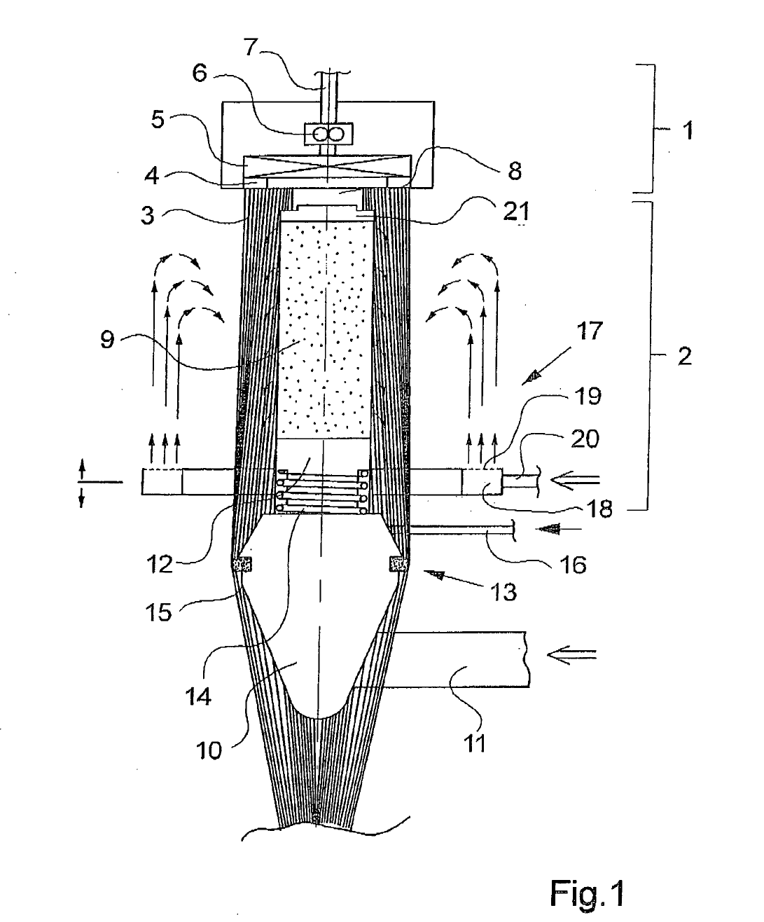

FIG. 1 schematically illustrates a first embodiment of the apparatus according to the invention and which is adapted to carry out the method of the invention. The apparatus comprises a spin unit 1 and downstream thereof a cooling unit 2. The spin device 1 mounts on its underside an annular spinneret 4, which includes an annular plate with a plurality of spin holes on a bottom surface thereof. The annular spinneret 4 connects via a melt distributor 5 to a spin pump 6. The spin pump 6 connects via a melt line 7 to a melt producer (not shown), preferably an extruder or a polycondensation device. The spin pump 6, melt distributor 5, and annular spinneret 4 are heated. To this end, so-called spin beams are used, which mount a plurality of annular spinnerets side by side in one line.

The cooling unit 2 downstream of the spin unit 1 comprises a holding device 10 and an air diffuser 9 connected to the holding device 10. The air diffuser 9 has a porous jacket, which may be made of a nonwoven, foam, mesh fabric, or sintered material. At its free end, a centering shoulder 21 closes the air diffuser. The centering shoulder 21 is used to lock the air diffuser 9 in a vertical position. The selection and quality of the centering shoulder make it possible to adjust different heights of the air diffuser. The air diffuser 9 is held in concentric relationship with the annular spinneret 4, so that an extruded annular group of filaments leaving the annular spinneret 4, surrounds it. The group of filaments extruded by the annular spinneret 4 is indicated by numeral 3.

A connection element 12 adjustably joins the air diffuser 9 in the axial direction to the holding device 10. A cooling unit of this type is disclosed, for example, in EP 1 231 302 A1, and U.S. Patent Publication 2002/0119210A1, the disclosures of which are expressly incorporated herein by reference. In the position illustrated in FIG. 1, the cooling device is in its operating state. In this state, a spring 14 is operative between the cooling unit 10 and the connection element 12, so that the air diffuser 9 is held with the centering shoulder 21 against a stop 8. The stop 8 extends directly in the center of the underside of annular spinneret 4. As is known from the contents of EP 1 231 302 A1 and U.S. 2002/0119210A1, the spring 14 may also advantageously be replaced with a pneumatic cylinder for keeping the air diffuser in its operating position.

To supply cooling air to the air diffuser 9, an air supply line 11 connects to the holding device 10. Inside the holding device 10, a pressure chamber is formed which connects to the interior of the air diffuser 9.

At the lower end of the air diffuser 9, in the region of the holding device 10, the cooling unit 2 comprises an air discharge member 17 that extends outside of the filament sheet formed by the filament group 3. The air discharge member 17 is constructed as an annular air nozzle 18, which surrounds substantially the entire circumference of the filament sheet formed by the group of filaments 3. Between the air nozzle 18 and the filament group 3, a spacing is formed, which is dimensioned such that an outer cooling airflow generated by the air nozzle 18 is guided into the outer surroundings of the filament group 3. To this end, the air nozzle 18 includes an outlet opening 19 that is directed against the direction of advance of the filament group 3. The air nozzle 18 connects via a connection line 20 to a source of compressed air (not shown). The air nozzle 18 is made vertically adjustable in its position along the cooling length, as is indicated by arrows in FIG. 1. To this end, the air nozzle 18 could be mounted in a linear guideway that is movable in the longitudinal direction of the air diffuser 9.

On the circumference of the holding device 10, a lubrication device 13 is provided, which includes a lubrication ring 15 arranged on the holding device 10. The lubrication ring 15 receives from the inside a liquid lubricant, which is supplied via a lubricant line 16.

In the operating state, the spin pump 6 supplies a molten polymer via the melt distributor 5 to the annular spinneret 4. Inside the annular spinneret 4, the polymer melt is extruded through a plurality of spin holes formed in the underside, so that a plurality of strandlike filaments forms. The extruded group of filaments 3 forms a downwardly advancing annular filament sheet, which is uniformly withdrawn from the annular spinneret 4 by a withdrawal system (not shown).

For cooling the freshly extruded group of filaments 3, a cooling medium, preferably cooling air is supplied via the air supply line 11 to a pressure chamber formed in the interior of the holding device 10. From the pressure chamber, the cooling medium is supplied via the hollow cylindrical connection element 12 into the interior of the air diffuser 9. The cooling medium then flows uniformly outward through the jacket of the air diffuser 9. On the circumference of the jacket of air diffuser 9, a radial outflow develops, which guides an inner cooling airflow in the direction of the filament group 3. The inner cooling airflow penetrates the filament group 3, and is largely entrained with the filaments of the filament group 3.

At the same time, a further cooling medium, preferably likewise a cooling air is supplied to the air nozzle 18. The air nozzle 18 generates through its outlet opening 19 an outflow that is directed parallel to but opposite to the direction of advance of the filament group 3. This outflow directs an outer cooling airflow into the immediate outer surroundings of the filament group 3. The outer cooling airflow mixes with the ambient air and is entrained in particular by the outer filaments of the filament group 3. With that, the filament sheet formed by the group of filaments 3 is cooled from the inside and the outside.

Once the filaments of the group 3 are cooled, they receive a spin finish in the lubrication device 13. To this end, a lubricant is supplied via the line 16 to the lubrication ring 15. The lubrication ring 15 could be made of a porous material, so that the lubricant evenly distributes in the lubrication ring 15 and exits from the surface for lubricating the filaments. After the lubrication, the filament bundle is ready for further processing. For example, the group of filaments could be combined to yarns and be wound, or it could be combined to a tow and be deposited in a can.

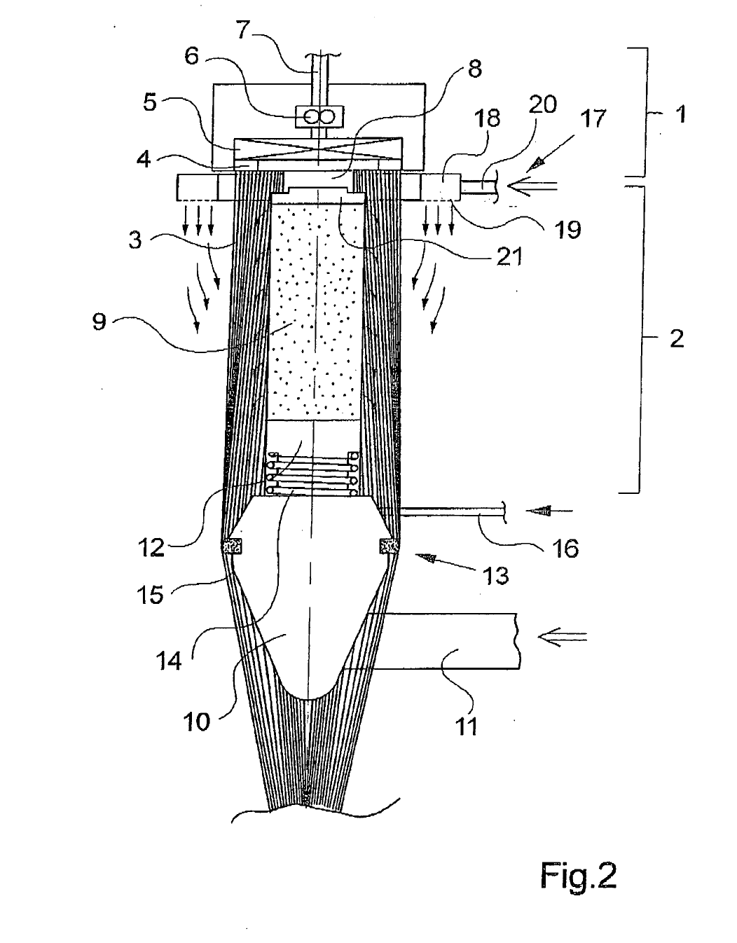

FIG. 2 shows a schematic cross sectional view of a further embodiment of the apparatus according to the invention for carrying out the method of the invention. The embodiment is largely identical with the foregoing embodiment of FIG. 1, so that the foregoing description is herewith incorporated, and only differences are described. To this end, components of like function have been provided with like numerals.

In the embodiment of the apparatus according to the invention as shown in FIG. 2, the air discharge member 17 is formed outside of the filament sheet of the filament group 3 by an air nozzle 18. The air nozzle 18 is arranged in the immediate vicinity of spin unit 1, preferably on the underside of the spinneret 4. The air nozzle 18 is made annular and mounted in essentially concentric relationship with the spinneret 4. The outlet opening 19 is formed in the underside of the air nozzle 18, so that it is possible to generate an outflow parallel to the direction of advance of the filament group 3. The air nozzle 18 connects via the connection line 20 to a coolant source (not shown). The distance of the outlet opening 19 and air nozzle 18 from the group of filaments 3 extruded from the annular spinneret 4 is dimensioned such that an outer cooling airflow is guided directly in the vicinity of the filament group 3.

For cooling the filament group 3, the air diffuser 9 generates a radially emerging inner cooling airflow, and the air nozzle 18 an outer cooling airflow that flows parallel to the direction of advance of the filament group 3. The outer cooling airflow and the inner cooling airflow are adjustable independently of each other as regards the quality of the coolant, and separately with respect to the intensity of the cooling airflow. Preferably, the inner cooling airflow is generated of a greater intensity for obtaining a uniform expansion of the group of filaments 3 that form the filament sheet. With that, the cooling effect of the outer cooling airflow is intensified, since the spacing between the outer filaments is enlarged by the expansion.

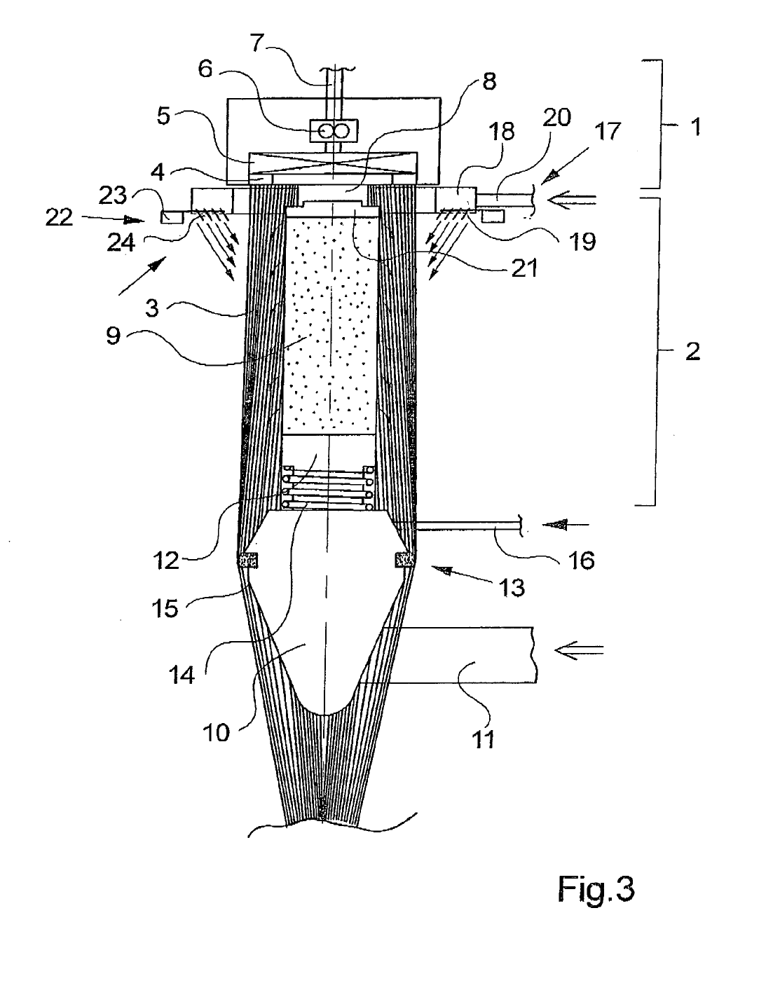

FIG. 3 schematically illustrates a further embodiment of the apparatus according to the invention with a further variant of the cooling unit 2. The embodiment is identical with the foregoing embodiments, so that their foregoing descriptions are herewith incorporated by reference, and that only differences are described.

The air discharge member 17 of the cooling unit 2 downstream of the spin unit 1 comprises the air nozzle 18, which is mounted in the vicinity of the spin unit 1. On its underside, the air nozzle 18 includes an annular outlet opening 19. Associated to the outlet opening 19 is an adjustment member 22 for changing the outflow. The adjustment member 22 is formed by a plurality of shutters 24 that are arranged parallel in a side-by-side relationship, and which can be adjusted in their position by an actuator 23. The shutters 24 in the outlet opening 19 lead to an orientation of the outflow of the generated outer cooling airflow. Thus, it is possible to realize the outflow in any desired angular position relative to the filament group 3. In the embodiment shown in FIG. 3, the shutters 24 are inclined in the direction of the filament group 3. With that, the outflow generated by the outlet opening 19 is directed toward the filament group 3. The air nozzle 18 thus directs the outer cooling airflow toward the filament group 3. Consequently, the present embodiment is especially suited for cooling relatively coarse filaments with a corresponding high filament density of the filament group 3.

The embodiments of the apparatus according to the invention for carrying out the method of the invention as shown in FIGS. 1-3, are exemplary in their construction and type. The invention relates not only to the embodiments illustrated therein, but also encompasses any spinning apparatus that is commonly known to the skilled person, and in which an annular group of filament is produced to form a filament sheet. Thus, for example, it is possible to produce the group of filaments 3 by a plurality of spinnerets that are mounted in an annular arrangement. Likewise exemplary are the illustrated embodiments for generating the outer and the inner cooling airflows. Essential is that the annular group of filaments 3 be cooled from the inside and the outside. Thus, for example, it is possible to combine the air diffuser with an outer, annular transverse airflow, whose outflow is adjustable by a plurality of shutters.

That which is claimed:

1. A method for melt spinning and cooling a group of filaments, comprising the steps of
extruding a melt through a plurality of spin holes of an annular spinneret to form a downwardly advancing annular group of filaments,
cooling the group of filaments by an inner cooling airflow that is generated from an air diffuser in the interior of the group of filaments, and
additionally cooling the group of filaments by an outer cooling airflow that is generated outside of the group of filaments.

2. The method of claim 1 wherein the outer cooling airflow is directed substantially parallel to the advancing direction of the group of filaments.

3. The method of claim 2 wherein the outer cooling airflow is directed substantially parallel to and opposite to the advancing direction of the group of filaments.

4. The method of claim 2 wherein the outer cooling airflow is directed substantially parallel to and in the advancing direction of the group of filaments.

5. The method of claim 1 wherein the outer cooling airflow is directed in spaced relationship with the group of filaments and then caused to move into the external periphery of the group of filaments.

6. The method of claim 1 wherein the outer cooling airflow is generated in a variable angular direction toward the outer periphery of the group of filaments.

7. The method of claim 1 wherein the outer cooling airflow is generated from a variable position downstream of the annular spinneret to permit cooling a section only of the length of the group of filaments.

8. The method of claim 1 wherein the inner cooling air flow is directed in a generally radial direction about the entire inner circumference of the group of filaments, and wherein the outer cooling airflow is directed about the entire outer circumference of the group of filaments.

9. The method of claim 1 wherein the intensities of the inner and outer cooling airflows are such that the inner cooling airflow acts to radially expand the annular group of filaments.

10. An apparatus for melt spinning a group of filaments, comprising
a melt spin unit which includes an annular spinneret having a plurality of spin holes on a bottom surface thereof for extruding a melt therethrough and forming a downwardly advancing annular group of filaments,
a cooling system for generating an inner cooling airflow within the annular group of filaments and comprising an air diffuser mounted below the spinneret and centrally within the annular group of filaments, and an air supply connected to the diffuser for delivering air to the diffuser so that an outwardly directed cooling airflow is generated in the interior of the annular group of filaments, and
an additional cooling system for generating an outer cooling airflow and comprising an air discharge member arranged on the outside of the annular group of filaments for generating a cooling airflow on the outside of the annular group of filaments.

11. The apparatus of claim 10 wherein the air discharge member comprises an annular air nozzle having an outlet opening that is oriented parallel to the advancing direction of the group of filaments.

12. The apparatus of claim 11 wherein the annular air nozzle is arranged in spaced relationship with the spin unit, with the outlet opening of the air nozzle being oriented oppositely to the advancing direction of the group of filaments.

13 The apparatus of claim 11 wherein the annular air nozzle is arranged immediately adjacent the spin unit with the outlet opening being directed in the advancing direction of the group of filaments.

14. The apparatus of claim 11 wherein the annular air nozzle is arranged in spaced relationship with the group of filaments in such a manner the cooling airflow emerging from the outlet opening is directed into the outer periphery of the group of filaments.

15. The apparatus of claim 10 wherein the air discharge member includes at least one adjustment member for adjusting the angular position of the outflow of the cooling airflow toward the group of filaments.

16. The apparatus of claim 10 wherein the air discharge member is vertically adjustable, so that the outer cooling airflow can be generated at a variable position downstream of the spin unit.

17. The apparatus of claim 10 wherein the air diffuser is mounted so as to be vertically adjustable in an axial direction relative to a holding device which is positioned centrally within the annular group of filaments.
